(19) United States
(12) Patent Application Publication
(10) Pub. No.: US 2007/0060349 A1
(43) Pub. Date: Mar. 15, 2007

(54) SYSTEM FOR EMPLOYING VIDEO SEGMENTS IN THE PRESENTATION OF A WAGERING GAME

(76) Inventors: Brandon F. Fish, Pflugerville, TX (US); Marc R. Pestien, Austin, TX (US); Michael D. Conway, Austin, TX (US)

Correspondence Address: THE CULBERTSON GROUP, P.C., 1114 LOST CREEK BLVD., SUITE 420, AUSTIN, TX, 78746, US

(21) Appl. No.: 11/531,654

(22) Filed: Sep. 13, 2006

Related U.S. Application Data
(60) Provisional application No. 60/716,452, filed on Sep. 13, 2005.

(51) Int. Cl. A63F 13/00

(52) U.S. Cl. 463/31

(57) ABSTRACT

A method includes receiving a game play initiating input at a player station and displaying a video-transitioning symbol in response to the game play initiating input. This video-transitioning symbol is displayed in a game play result conveying graphic on a display device associated with the player station, and may include a reel symbol in a video simulation of a reel-type game display, or may include some feature in a bonus game display, for example. The method also includes modifying the video-transitioning symbol to display a video segment within the game play result conveying graphic. The video segment may be displayed in a small area of the game play result conveying graphic, such as the area defined for a reel symbol making up the video-transitioning symbol for example. Alternatively, the video segment may be displayed in an area larger than the area taken up by the video-transitioning symbol. The video segment may be accompanied by a complementing audio segment generated by a suitable audio device at the player station.

### CROSS-REFERENCE TO RELATED APPLICATION

The Applicants claim the benefit, under 35 U.S.C. § 119(e), of U.S. Provisional Patent Application No. 60/716,452 filed Sep. 13, 2005, and entitled “System for Presenting Gaming Results in a Player Selection Format.” The entire content of this provisional application is incorporated herein by this reference.

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all rights of copyright.

### TECHNICAL FIELD OF THE INVENTION

This invention relates to gaming machines and systems. More particularly, the invention relates to methods for presenting gaming results to a player through a video generated game presentation that employs a player selection options.

### BACKGROUND OF THE INVENTION

A large number of different gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Video-based gaming machines may also be used to show card games or various types of competitions such as simulated horse races in which wagers may be placed. Game manufacturers are continuously pressed to develop new game presentations, formats, and game graphics in an attempt to provide high entertainment value for players and thereby attract and keep players.

### SUMMARY OF THE INVENTION

The present invention includes a highly entertaining method of presenting gaming results. The entertainment value is achieved by incorporating video segments into the result conveying portion of the game display. The present invention also encompasses both gaming devices and program products for implementing methods according to the invention.

A method embodying principles of the invention may be implemented using one or more display devices such as CRTs, LCDs, plasma displays, or other types of display devices. The display device or devices used to show graphic elements according to the invention will commonly be associated with a gaming machine through which a player may participate in a game. As used in this disclosure and the accompanying claims, a gaming machine through which the present invention may be implemented will be referred to generally as a player station.

One preferred method according to the present invention including receiving a game play initiating input at a player station and displaying a video-transitioning symbol in response to the game play initiating input. This video-transitioning symbol is displayed in a game play result conveying graphic on a display device associated with the player station, and may include a reel symbol in a video simulation of a reel-type game display, or may include some feature in a bonus game display, for example. The method also includes modifying the video-transitioning symbol to display a video segment within the game play result conveying graphic. In some forms of the invention the video segment may be displayed in a small area of the game play result conveying graphic, such as the area defined for a reel symbol making up the video-transitioning symbol for example. Alternatively, the video segment may be displayed in an area larger than the area taken up by the video-transitioning symbol, although the video segment is still shown in at least a portion of the area of the game play result conveying graphic. This game play result conveying area is to be distinguished from tangential displays that may be included with the player station that do not directly display a graphic, such as a set of reel symbols, that conveys a result for a play in the game. Regardless of the area used for the video segment, the video segment may be accompanied by a complementing audio segment generated by a suitable audio device at the player station.

Displaying a video segment according to the present invention allows the result for a game play to be conveyed to the player in an entertaining format, that may draw on the popularity of television shows, movies, and other popular forms of entertainment. For example, the video segment may show a clip of a character from a popular television show or movie. These video segments may be coordinated with an overall theme for the player station.

An apparatus embodying the principles of the invention may include a display device, a player input device, and a presentation controller. The presentation controller in this apparatus causes the display device to display the video-transitioning symbol in a game play result conveying graphic as described above in response to a game play initiating input entered through the player input device. The presentation controller also causes the video display device to modify the video-transitioning symbol to display a video segment within the game play result conveying graphic. In one preferred form of the invention, the presentation controller comprises the main processing device for the player station, and executes operational program code to provide the desired control functions.

A program product embodying one preferred form of the invention includes game graphic program code and video segment control program code. The game graphic program code is executable by a suitable processor to cause a player station display device to display the video-transitioning symbol as described above. That is, the video-transitioning symbol is displayed in a game play result conveying graphic in response to a player input entered through a player input device at the player station. The video segment control program code is executable to cause the player station display device to modify the video-transitioning symbol to display the video segment as described above. Ths video segment is displayed within at least a portion of the game play result conveying graphic as opposed to any tangential display that does not convey the results of game play to the player.

The result displayed to a player according to the invention may be obtained in any suitable fashion. In some forms of the invention, the apparatus may receive results identified from a separate device or system. Particularly in these forms of the invention, the result may actually be a result from an electronic lottery game, a bingo game, or some other game. In other forms of the invention, a result controller may be included at the player station and adapted to communicate a game play result to the presentation controller in response to a result requesting input entered through the input device. Whether the result is obtained from a separate device or from some component at the player station itself, the presentation controller controls the symbols displayed in the course of a game cycle to be consistent with the given result. The result produced by the local result controller or received from a remote result controller for a given play in the game preferably dictates both the result displayed in the base game presentation and the result displayed in any bonus game presentation provided at the player station. Regardless of any underlying game from which a result is identified in the present invention, a “play” or “game play” referenced in this disclosure will refer to the game cycle of a graphic presentation according to the invention. The game cycle comprises a cycle from the point at which a play in the game is initiated, through any symbol change process associated with the initial game graphic (such as simulated spinning reels), and through any bonus play graphic for a given symbol change process (such as any first screen or second screen bonus game triggered by the results from the reel spin).

These and other advantages and features of the invention will be apparent from the following description of preferred embodiments, considered along with the accompanying drawings.

### BRIEF DESCRIPTION OF THE DRAWINGS

FIG. 1 is a perspective view of a player station that may be used to implement a game presentation employing video segments according to the invention.

FIG. 2 is a diagrammatic representation of a player station and gaming system that may be used to implement methods according to the present invention.

FIG. 3 is a flow chart representing a process of displaying gaming result according to one preferred form of the invention.

FIG. 4 is a representation of a reel-type graphic display that may be generated as part of a base game presentation that may employ video segments according to the present invention.

FIG. 5 is a representation of a portion of a paytable correlating arrangements of reel symbols with various prizes in the result displaying component shown in FIG. 4.

FIG. 6 is a representation of another portion of a paytable correlating arrangements of reel symbols with various prizes in the result displaying component shown in FIG. 4.

FIG. 7 is a representation of another portion of a game presentation according to the invention, showing bonus game information.

FIG. 8 is a representation of player selection screen for a second screen bonus game presentation according to one form of the invention.

FIG. 9 is a representation of the second screen bonus game presentation in progress after the player's selection from the screen shown in FIG. 8, and indicating the result of the player's choice.

FIG. 10 is a representation of an attract screen embodying the principles of the invention.

### DESCRIPTION OF ILLUSTRATIVE EMBODIMENTS

The claims at the end of this document set out novel features which the Applicant believes are characteristic of the invention. The various advantages and features of the invention together with preferred modes of use of the invention will best be understood by reference to the following description of illustrative embodiments read in conjunction with the drawings introduced above.

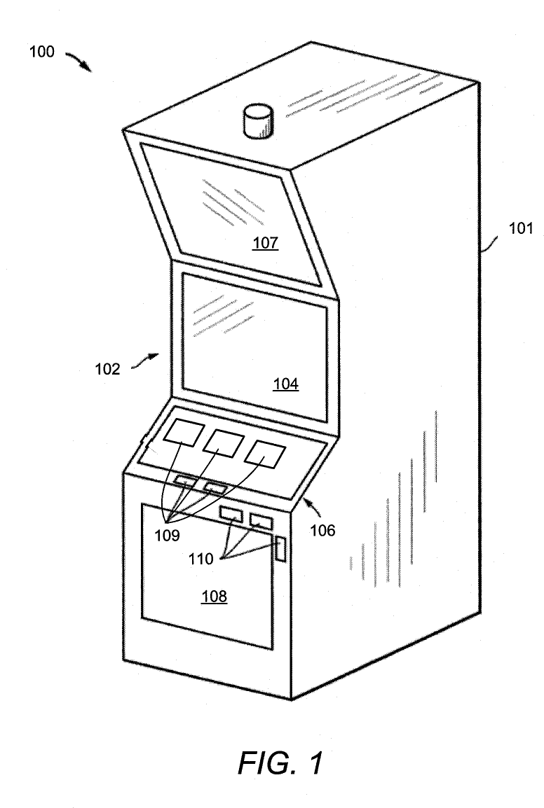

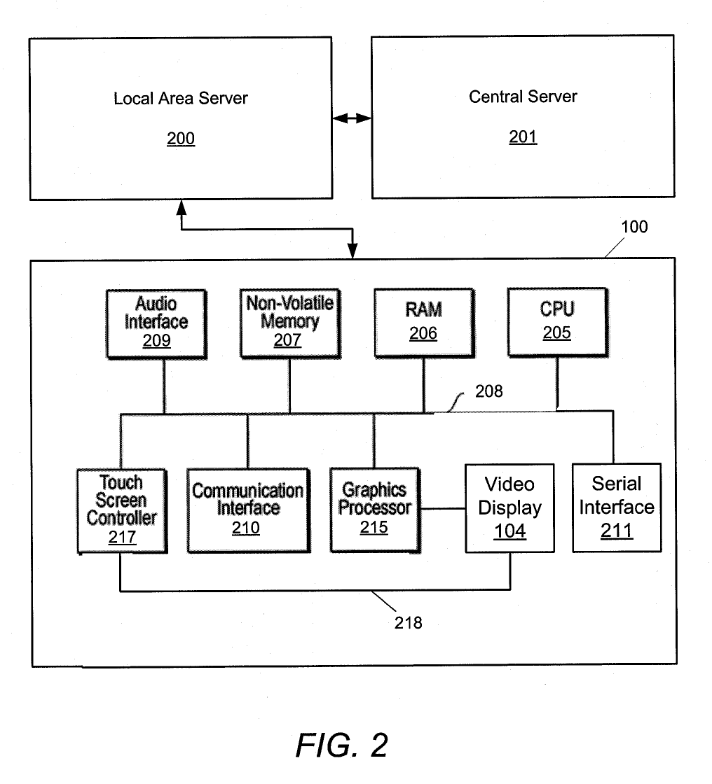

FIG. 1 shows a player station 100 that may be used to implement game presentations according to the present invention. The block diagram of FIG. 2 shows further details of player station 100 connected in a gaming system in which the present invention may be used to present gaming results to players.

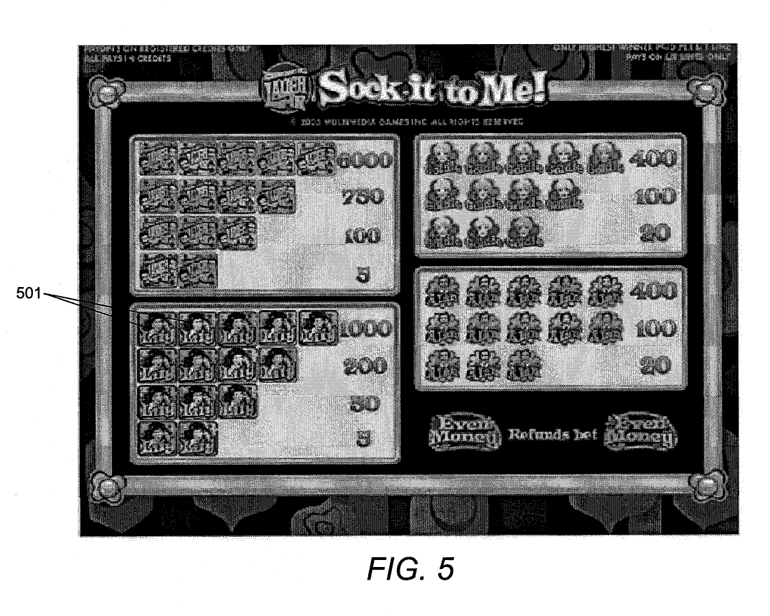

Referring to FIG. 1, player station 100 includes a cabinet 101 having a front side generally shown at reference numeral 102. A video display device 104 is mounted in a central portion of the front surface 102, with a ledge 106 positioned below the video display device and projecting forwardly from the plane of the video display device. In addition to the video display device 104, the illustrated player station includes a top glass display 107 positioned above the video display device, and a belly glass display 108 positioned below the video display device. In the illustrated player station 100, video display device 104 is used to produce the graphic components making up the game presentation according to the invention. That is, video display device 104 displays the symbol locations and graphic symbols contained in those locations, displays the change processes shown at the symbol locations, and also displays the symbols that correlate to the player's result for a game play. In player station 100, top glass display 107 and bottom glass display 108 contain static graphics related to the particular game presentation. For example, top glass display 107 may show a paytable such as the paytable described below in connection with FIG. 5. Bottom glass display 108 may show additional graphics related to the graphics shown at top glass display 107 and video display device 104.

Player station 100 illustrated in FIG. 1, includes mechanical player control buttons or other input devices 109 mounted on ledge 106. Other forms of the invention may include switches, joysticks, or other player input devices mounted on ledge 106.

It will be appreciated that player stations may also include player interface devices in addition to devices that are considered player controls for use in playing a particular game. Player station 100 also includes additional player interface devices 110 on a lower portion of cabinet 101 generally in the plane of bottom glass display 108. These additional player interface devices 110 may comprise for example, a player card reader, a voucher or ticket reader/issuer, a currency acceptor/validator, and/or a coin or token acceptor/dispenser.

It should be noted that the present invention is by no means limited to implementation with a player station having a single video display such as player station 100 shown in FIG. 1. A game presentation made according to some forms of the present invention may be produced with any player station that includes a player interface for enabling a player to make direct inputs, and one or more video display devices, or physical reel arrangements through which the various graphic elements of the game presentation may be produced. Player station 100 is merely shown as an example of a player station through which the invention may be implemented. Other player stations implementing the present invention may include other types of devices that may show game play results. For example, a player station may include a spinning wheel to show results. These other types of result display devices may be used to show some gaming results to the player, while the presentation according to the invention may be used to show other results. It should also be noted that the video display device 104 used in player station 100, or some other player station that may be used to implement the invention, may comprise any suitable video display device including a cathode ray tube, liquid crystal display, plasma display, LED display or any other type of video display currently known or that may be developed in the future.

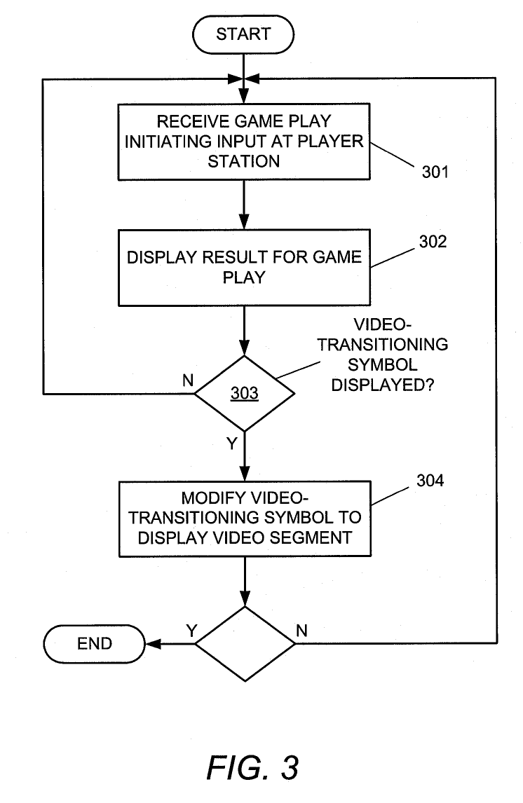

FIG. 2 provides a block diagram showing various components of player station 100 together with gaming system components external to the player station. In particular, FIG. 2 shows player station 100 connected for communication with a local area server 200 and a central server 201. Local area server 200 and central server 201 may be used together with player station 100 and other player stations to implement a bingo gaming system, such as the bingo gaming system described in U.S. patent application publication No. 2004-0152499-A1, or to implement a lottery gaming system such as the lottery gaming system shown in U.S. patent application publication No. 2005-0137010-A1 or U.S. Pat. No. 6,733,385, for example. Regardless of the precise manner in which results are identified in a given system, local area server 200 and central server 201, or both servers, may cooperate to identify results that are provided to player station 100 in response to a result requesting input entered at the player station. That is, local area server 200 and/or central server 201, or more particularly, one or more processing devices associated with server 200 and/or server 201 may serve as a result controller for identifying results used by player station 100 as described further below with reference to FIG. 3. Even in implementations in which results are produced at the player station 100 in some fashion, local area server 200 and/or central server 201 may be used to provide player tracking and accounting services for the player stations included in the gaming system.

FIG. 2 shows that player station 100 includes a central processing unit (CPU) 205 along with random access memory 206 and nonvolatile memory or storage device 207. All of these devices are connected on a system bus 208 with an audio interface device 209, communications interface 210, and a serial interface 211. A graphics processor 215 is also connected on bus 208 and is connected to drive the video display device 104 (mounted on cabinet 101 as shown in FIG. 1). As shown in FIG. 2, player station 100 also includes a touch screen controller 217 connected to system bus 208. Touch screen controller 217 is also connected via signal path 218 to receive signals from a touch screen element associated with video display device 104. It will be appreciated that the touch screen element itself comprises a thin film that is secured over the display surface of video display device 104. The touch screen element itself is not illustrated or referenced separately in the figures.

Those familiar with data processing devices and systems will appreciate that other basic components will be included in player station 100 such as a power supply, cooling systems for the various system components, audio amplifiers and speakers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217. Thus, the touch screen controller may not be connected to the system bus 208, but instead include a serial communications line to serial interface 211, which may be a USB controller or a IEEE 1394 controller for example. It will also be appreciated that some of the devices shown in FIG. 2 as being connected directly to system bus 208 may in fact communicate with the other system components through a suitable expansion bus. Audio interface 209, for example, may be connected to the system via a PCI bus. Numerous other variations in the player station internal structure and system may be used without departing from the principles of the present invention.

It will also be appreciated that graphics processors are also commonly a part of modern computer systems. Although separate graphics processor 215 is shown for controlling video display device 104, it will be appreciated that CPU 205 may control the video display device directly without any intermediate graphics processor. The invention is not limited to any particular arrangement of processing devices for controlling the video display device.

In the illustrated player station 100, CPU 205 executes software which ultimately controls the entire player station including the receipt of player inputs and the presentation of the graphic symbols at the various symbol locations displayed according to the invention through the video display device 104 associated with the player station. Thus, CPU 205 either alone or in combination with graphics processor 215 serves as a presentation controller according to the invention. Where the player station itself produces results for a player, CPU 205 also serves as a result controller. CPU 205 also executes software related to communications handled through communications interface 210, and software related to various peripheral devices such as those connected to the system through audio interface 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of player station operation. Communications interface 210 provides an interface to other components of a gaming system that may be involved in game play, such as local area server 200 and/or central server 201.

It should be noted that the invention is not limited to player stations employing the personal computer-type arrangement of processing devices and interfaces shown in example player station 100. Other player stations may include one or more special purpose processing devices to perform the various processing steps for implementing the present invention. Unlike general purpose processing devices such as CPU 205, these special purpose processing devices may not employ operational program code to direct the various processing steps.

The following description describes the operation of a game presentation (base game presentation and/or bonus game presentation) that may be displayed at a player station such as player station 100 in accordance with forms of the present invention. In addition to the displays described below and shown in the figures, a process according to the present invention may also receive or produce a result for the game cycle at a suitable point of the game presentation process. For example, the player input to initiate a play in the game may prompt the player station to request a result from a result controller at the player station or elsewhere in the gaming system (such as components 200 or 201 in FIG. 2). The result controller then communicates back a result for the game cycle. The result or data included in or correlating to the result may then be used at the player station to control the display produced at the player station. In particular, the player station ultimately displays an arrangement of symbols consistent with the result that has been assigned for the game cycle. It will be appreciated, however, that a result may be received at a number of appropriate points in the game presentation. For example, a result for a play in the game may be obtained while the process is conducting the symbol change processes (for example, spinning the reels in the result conveying component of the game graphic). It should also be noted that the invention is not limited to applications where a result is obtained and the graphics are forced to correspond to that result. Rather, the reel spinning process (simulated reel spinning process) may be the process that dictates the result for the game cycle. That is, the process may use some random or pseudo-random process to select the reel symbols ultimately displayed at the various symbol locations to dictate the result for the play in the game.

Certain preferred processes embodying the principles of the invention may be described with reference to the flowchart shown in FIG. 3. One preferred process includes receiving a game play initiating input, that is, a game play request, at the player station as indicated at process block 301. The player station may be player station 100 shown in FIGS. 1 and 2 for example. The game play initiating input may be any suitable input. For example, a game play initiating input as indicated at process block 301 in FIG. 3 may be made by pressing a physical or virtual “play” button or pulling a handle at the player station. Other forms of the invention may require several different actions at the player station which together make up a game play initiating input. Entering a bet level and/or selecting pay lines at the player station in addition to activating a “play” button or handle is an example of an arrangement requiring multiple actions to produce a game play initiating input at the player station.

In response to the game play initiating input received as indicated at process block 301 in FIG. 3, the process includes ultimately displaying a result for the game play as indicated at process block 302. It will be appreciated that there may be a number of separate process steps between the input received at process block 301 and displaying the result as indicated at process block 302 in a given implementation of the invention. For example, the game play initiating input at the player station may result in a communication from the player station to a remote result generating component requesting a result for the game play. The request to the remote device may, for example, be a request for a result in a lottery game or a request for a play in a bingo game conducted at the remote processing device (such as local area server 200 and or central server 201 and FIG. 2). In the other forms of the invention, the result displayed as indicated at process block 302 in FIG. 3 may be generated either at the remote device or the player station itself from a suitable result generating algorithm. Because invention is not limited to any particular result generating technique and such techniques are in any event well known in the art, specifics of result generating techniques and the various actions which may be required to produce a result according to a given technique will not be discussed further here.

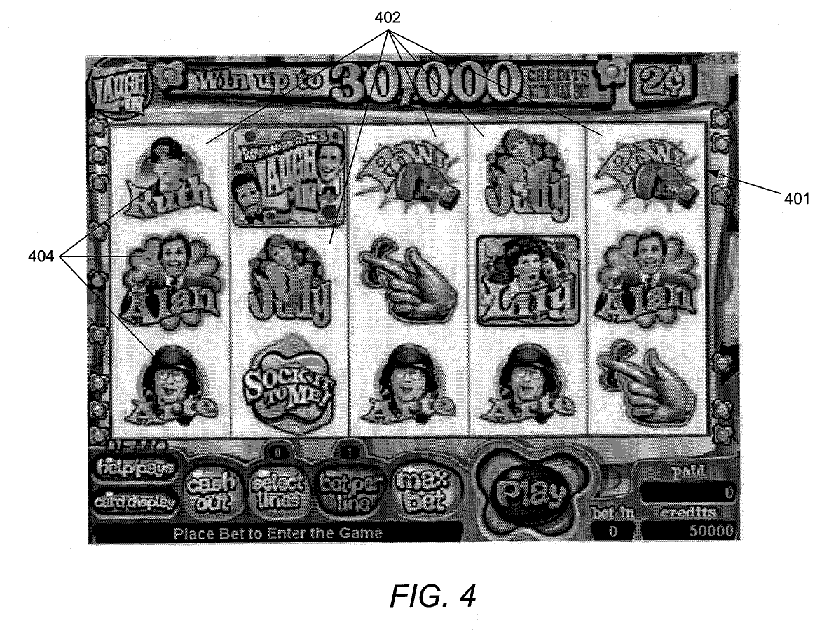

Regardless of how the result is generated or obtained at the player station, it will correspond to a result conveying graphic that may be displayed to the player at the player station to graphically convey the result to the player. For example, the result conveying graphic may be a simulation of a series of spinnable reels that ultimately come to rest with a set of reel symbols across a pay line, and the set of reel symbols corresponds to a result for the game play. Other result conveying graphics may be interactive or other bonus games or a combination of an initial reel-type display and some bonus game display. Example reel-type displays and bonus game displays will be described below with reference to FIGS. 4 through 10. However, it will be appreciated that the invention is not limited to displaying results through a reel-type display or any other type of display at a given player station.

The result conveying graphic displayed as indicated at process block 302 in FIG. 3 may or may not display a video-transitioning symbol as part of the result conveying graphic. If such a video-transitioning symbol is not displayed as indicated by a negative outcome at decision block 303, the process returns to wait for the next game play initiating input. However, if a video-transitioning symbol is displayed as indicated by a positive outcome at decision block 303, the process continues to modify the video-transitioning symbol to display a video segment within the game play result conveying graphic as indicated at process block 304. Thereafter, the process may terminate or may return to wait for the next game play initiating input at the player station.

It should be noted that there may be a number of steps to the process of displaying the result for the game play has indicated at process block 302, and that the video-transitioning symbol may appear in any of these result conveying displays. For example, a given result may be partly displayed by a set of reel symbols in an initial reel-type display produced at the player station in response to the game play initiating input, and a portion of the result may also be shown in a same screen or second screen bonus display. The video-transitioning symbol may be displayed at any part of the graphic display to convey the result to the player.

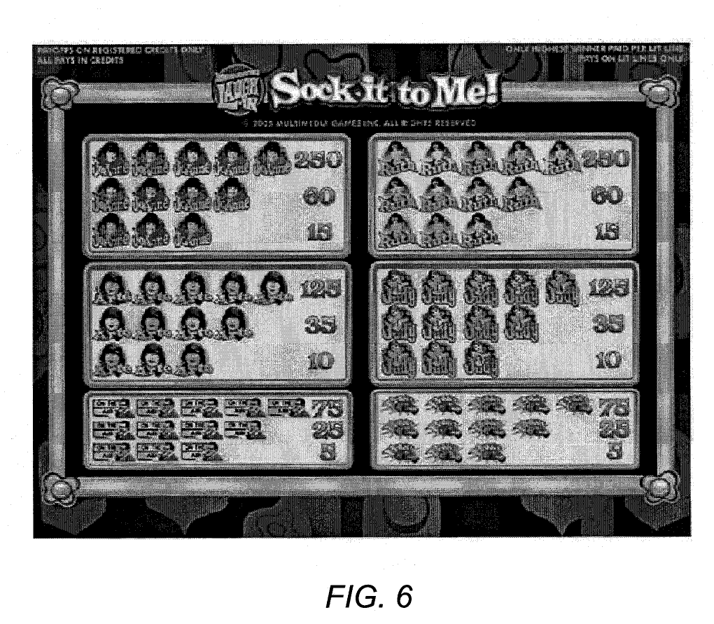

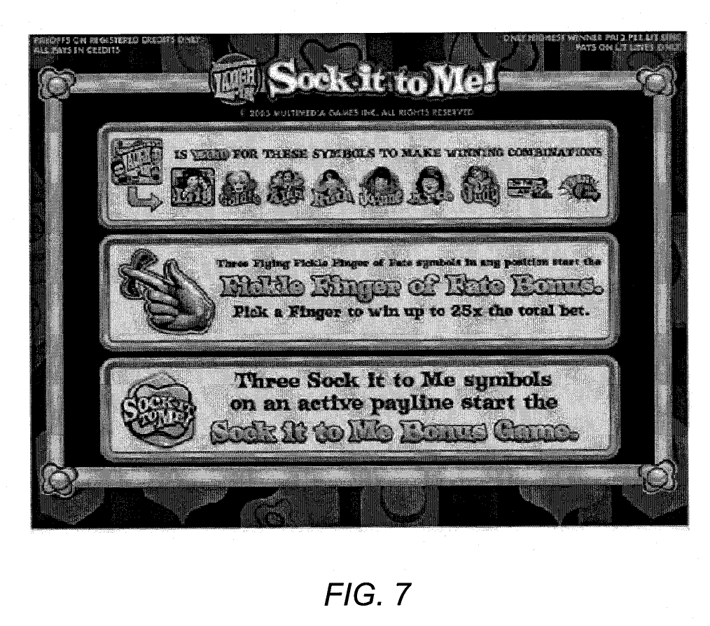

The example game presentation shown in FIGS. 4 through 10 may be used to describe the display of video segments according to the invention. As shown in FIG. 4, the example game presentation includes a 5-reel (video reel), 15 payline base game. The result for the base game portion of the game presentation is displayed in a result conveying graphic 401 made up of five simulated reels 402, each defining a column of three reel symbols 404. Some of these reel symbols 404 are representations of characters from the television series “Rowan & Martin's Laugh In,” and this television series provides an overall theme for the game presentation. FIGS. 5 and 6 show paytables listing various combinations of reel symbols 404 that correspond to winning results for the game presentation, associated with some award/prize to the player. The reel-type display shown in FIG. 4 shows a result by simulating a spin of the reels 402 from a first stationary position and then ultimately showing the reels come to rest. The content of the reel symbol array/matrix on the result conveying graphic 401 indicates at least a portion of the result of the play according to the pay definitions such as the definitions in FIGS. 5 and 6. FIG. 7 is a representation of an example display showing other game information. In particular, the display shown in FIG. 7 provides information on wild reel symbols, and information on two second screen bonus games.

An example of a video-transitioning symbol and the display of a video segment according to the invention may be described with particular reference to FIGS. 4 and 5 and to the flow chart of FIG. 3. As will be noted from FIG. 5, different numbers of character representations along an active payline through result conveying graphic 401 in FIG. 4, correspond to a win. For example, five “Lily” reel symbols 501 on an active payline corresponds to 1000 credits as shown in FIG. 5. In one form of the invention, the “Lily” reel symbol represents a video-transitioning symbol when it is included in a winning combination on a given payline in result conveying graphic 401 in FIG. 4. In that case, when the winning combination is displayed in result conveying graphic 401, one or all of the “Lily” reel symbols transition/morph into a video clip of the Lily character from the television show. The video segment may be shown as substantially the same size as the reel symbol in graphic display 401 in FIG. 4, and may be accompanied by a complementing audio track. For example, an audio/video segment may show the Lily character making some line from the television series. Some preferred forms of the invention store several different video and synchronized audio segments for each character in a suitable storage device at the player station (e.g. RAM 206, or nonvolatile memory 207 shown in FIG. 2), and select one of the audio/video segments for each modification process shown at 304 in FIG. 3. The selection may be random, according to some set sequence, or made in some other fashion.

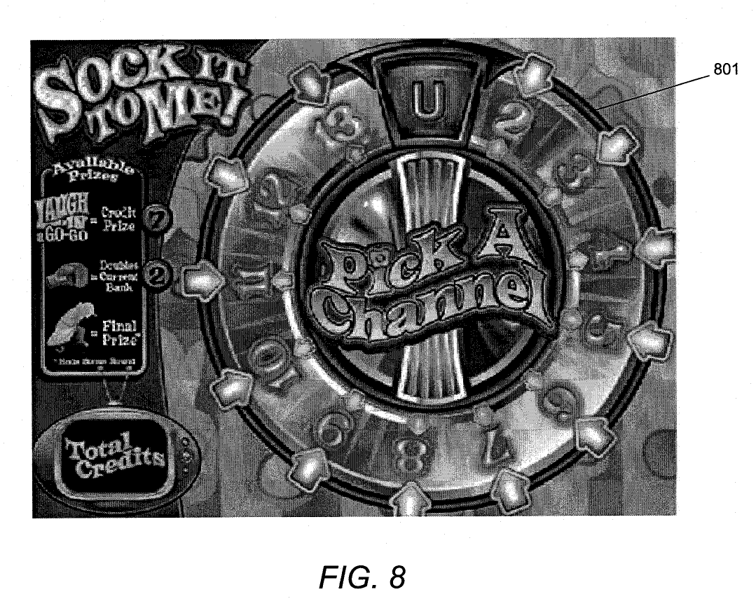

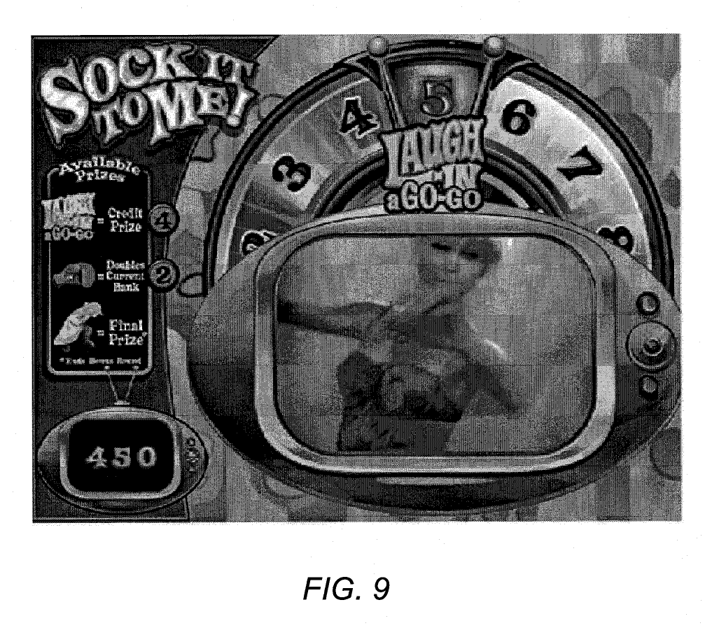

FIGS. 8 and 9 may be used to describe another video-transitioning symbol and modification process in the context of a bonus game display according to the present invention. FIG. 8 provides a representation of a second screen bonus display for an interactive bonus game. In this game, the player is prompted to select a channel on the television dial graphic 801 shown in FIG. 8. The area of this television dial graphic 801 represents a result conveying graphic in this form of the invention. When a player selects a channel by a suitable selection technique (e.g. touchscreen display showing graphic 801), the player station may respond by showing one of two different styles of video segments, that is, short video clips. The selected channel representation represents the video-transitioning symbol in this form of the invention, and transitions/morphs to the video clip such as that shown in FIG. 9. The particular video segment indicated in FIG. 9 provides a prize for the player, while the other style of video segment, the “tricycle guy” video segment, ends the bonus game. The selection of a channel in this bonus game may also result in the boxing glove, “sock it to me” symbol being shown which causes the current credit amount for the bonus game to be doubled. The process of selecting channels continues until a channel selection transitions to the “tricycle guy” video segment. After the “tricycle guy” video segment is displayed, the total award for the bonus play is preferably shown in the display in some fashion and then the display transitions/switches back to the basic game screen such as that shown in FIG. 4, for example.

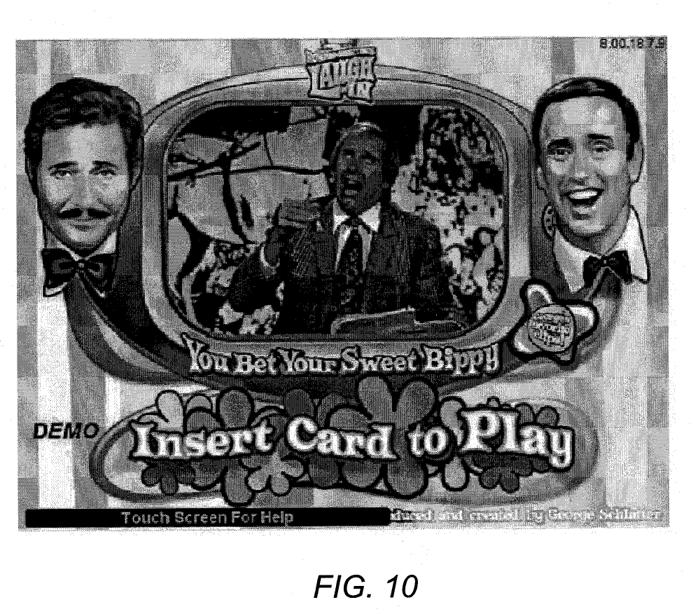

FIG. 10 shows a video clip attract mode employed according to one preferred form of the invention. When a player is not using the player station such as player station 100 shown in FIGS. 1 and 2, the presentation controller may, periodically go into an “attract” state. During this attract state, the player station will display some attract video segment, preferably from the television series, movie, or other object that provides the theme for the game. The video segments may include synced audio and may be for some appropriate period, such as 30 seconds for example.

In forms of the invention implemented through general purpose processing devices such as the devices shown in the example player station 100 of FIG. 2, the various steps described above and are performed under the control of operational program code. The invention encompasses the program products for performing the various steps described above. In particular, game graphic program code executable at CPU 205 in FIG. 2 may be responsible for displaying a result as indicated at process block 302 in FIG. 3. Video segment control program code may be executable at CPU 205 for causing the player station 100 to modify the video-transitioning symbol as described at process block 304 in FIG. 3.

The example displays shown in the figures are shown only as convenient examples for describing the principles of the invention. Many variations on these basic examples may be employed within the scope of the present invention. In particular, the invention is not limited to any particular manner for displaying the results for the game play. Also, numerous variations are possible in the playing rules of the game and the standards for presenting awards.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures (Eighth Edition, August 2001 as revised October 2005), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

1. A method including:
(a) receiving a game play initiating input at a player station;
(b) displaying a video-transitioning symbol in a game play result conveying graphic on a player station display device; and
(c) modifying the video-transitioning symbol to display a video segment within the game play result conveying graphic.

2. The method of claim 1 further including:
(a) displaying a first game graphic including a matrix of first game symbols;
(b) performing a symbol change process to replace one or more of the first game symbols to produce a second game graphic including a matrix of second game symbols, wherein the video-transitioning symbol is one of the second game symbols.

3. The method of claim 2 wherein modifying the video-transitioning symbol to display the video segment is performed in response to a winning combination of second game symbols along a payline defined through the matrix of second game symbols.

4. The method of claim 2 wherein the video-transitioning symbol includes a representation of an entertainment or story character and the video segment includes a segment showing the entertainment or story character represented in the video-transitioning symbol.

5. The method of claim 1 further including:
(a) displaying one or more additional video-transitioning symbols in the game play result conveying graphic on the player station display device; and
(b) modifying each of the one or more additional video-transitioning symbols to display a respective video segment within the game play result conveying graphic.

6. The method of claim 5 wherein modifying the video-transitioning symbol and each of the one or more additional video-transitioning symbols is performed in response to a winning combination of the video-transitioning and each of the one or more additional video-transitioning symbols along a payline defined through the result conveying graphic.

7. The method of claim 1 further including receiving a player input selecting the video-transitioning symbol and wherein the modifying the video-transitioning symbol is performed in response to the player input selecting the video-transitioning symbol.

8. The method of claim 1 wherein the video-transitioning symbol is displayed in a display area and further including expanding the display area to a larger video area in which the video segment is displayed.

9. The method of claim 1 wherein the video segment is displayed in a video display area defined by the video-transitioning symbol.

10. The method of claim 1 further including displaying an attract video segment when the player station is idle.

11. The method of claim 1 further including storing a number of alternative video segments for the video-transitioning symbol and wherein the video segment displayed at the player station is selected from the number of alternative video segments.

12. The method of claim 1 further including playing an audio segment at the player station synchronized to the video segment.

13. An apparatus including:
(a) a display device;
(b) a player input device;
(c) a presentation controller, the presentation controller for (i) causing the display device to display a video-transitioning symbol in a game play result conveying graphic on the display device in response to a game play initiating input entered through the player input device, and for (ii) causing the video display device to modify the video-transitioning symbol to display a video segment within the game play result conveying graphic.

14. The apparatus of claim 13 further including an audio playback system and wherein the presentation controller is also for causing the audio playback system to play an audio segment at the player station synchronized to the video segment.

15. The apparatus of claim 13 further including a data storage device for storing a number of alternative video segments for the video-transitioning symbol and wherein the video segment displayed at the player station is selected from the number of alternative video segments.

16. The apparatus of claim 13 wherein the presentation controller is also for (i) causing the display device to display a first game graphic including a matrix of first game symbols, and for (ii) causing the display device to perform a symbol change process to replace one or more of the first game symbols to produce a second game graphic including a matrix of second game symbols, wherein the video-transitioning symbol is one of the second game symbols.

17. The apparatus of claim 13 wherein the presentation controller causes the video display device to modify the video-transitioning symbol to display the video segment in response to a player selection of the video-transitioning symbol entered through the player input device.

18. A program product embodied in one or more computer readable media, the program product including:
(a) game graphic program code executable for causing a player station display device to display a video-transitioning symbol in a game play result conveying graphic in response to a player input entered through a player input device at the player station; and
(b) video segment control program code executable for causing the player station display device to modify the video-transitioning symbol to display a video segment within the game play result conveying graphic.

19. The program product of claim 18 wherein the game graphic program code is also executable for (i) causing the player station display device to display a first game graphic including a matrix of first game symbols, and for (ii) causing the display device to perform a symbol change process to replace one or more of the first game symbols to produce a second game graphic including a matrix of second game symbols, wherein the video-transitioning symbol is one of the second game symbols.

20. The program product of claim 19 wherein the video segment is displayed in an area defined for the video-transitioning symbol in the matrix of second game symbols.
